(19) United States
(12) Patent Application Publication
(10) Pub. No.: US 2023/0137737 A1
(43) Pub. Date: May 4, 2023

(54) DYNAMIC CONTEXT EXTRACTION FROM MEDIA STREAMS

(71) Applicant: NUANCE COMMUNICATIONS, INC., Burlington, MA (US)

(72) Inventors: Eduardo OLVERA, Phoenix, AZ (US); Abhishek ROHATGI, Roxboro (CA)

(73) Assignee: NUANCE COMMUNICATIONS, INC., Burlington, MA (US)

(21) Appl. No.: 17/518,786

(22) Filed: Nov. 4, 2021

(51) Int. Cl. G10L 15/08; G10L 15/07; G10L 15/18; G06N 20/00

(52) U.S. Cl. CPC G10L 15/083; G10L 15/075; G10L 15/1815; G06N 20/00

(57) ABSTRACT

A method of enabling a virtual assistant (VA) serving a user to dynamically acquire contextual information regarding digital media environment accessed by a user includes: extracting, by an analysis engine, the contextual information dynamically from at least one of media content accessed by the user and webpage content accessed by the user; and injecting, by the analysis engine, the extracted contextual information into a VA memory to serve the user. The analysis engine is configured to analyze the extracted contextual information using at least one machine learning (ML) model. The extracted contextual information includes at least one of topics, intents, entities, sentiments, and products of interest. The at least one ML model includes at least one of Automatic Speech Recognition (ASR), Natural Language Understanding (NLU), speaker diarization, sentiment analysis on media streams, and web analytics for product focus.

### BACKGROUND OF THE DISCLOSURE

### 1. Field of the Disclosure

The present disclosure relates to digital media content, and relates more particularly to dynamically extracting context of digital media surroundings of a virtual assistant from a media content.

### 2. Description of the Related Art

In the modern Internet environment, most of the digital enterprise platforms, e.g., finance, retail and/or travel websites, contain some form of media streams. Furthermore, virtual assistants (VAs) with conversational AI capabilities have been widely adopted for e-commerce support and marketing. In addition, increasing number of businesses are providing live or pre-recorded media streams (e.g., influencers' live talk, pre-recorded chat session, pre-recorded audio-visual performance, etc.) on the businesses' digital platforms to educate customers about their products and services.

To enrich the conversational AI experience of the customers on such digital platforms, it's very helpful to be able to serve the customers in context with the streamed live or pre-recorded events. However, VAs (also referred to as bots) are contextually unaware of, and/or unable to update their contextual awareness of, their shared digital environment, particularly when the digital surroundings are dynamic and constantly changing. For example, conventional contextual references for an omni-channel VA rely only on live interactions with the VA or capturing context references from the multiple channels being used to link to the VA.

Therefore, there is a need to enable VAs to learn about their digital surroundings context dynamically from digital sources (e.g., live, pre-recorded, off-line, static, etc.) in addition to the channels being used to link to the VA.

### SUMMARY OF THE DISCLOSURE

The present disclosure relates to a method and a system for enabling a VA to dynamically acquire contextual awareness of its digital media surroundings by extracting context dynamically from a media stream and injecting the acquired context directly into the VA dialog state.

According to an example embodiment of a method according to the present disclosure, identification and extraction of content on user interface is performed by an analysis engine, including identification and extraction of relevant objects on user interface which carry contextual value.

According to an example embodiment of a method according to the present disclosure, extracted web contents undergo analysis by the analysis engine using appropriate machine learning (ML) models.

According to an example embodiment of a method according to the present disclosure, contextual insight extraction is performed based on the ML models-based analysis by the analysis engine, including extraction of relevant topics, intents, entities, sentiments, and products of interest. Each ser utterance can be classified according to its intent. Intent, as used in the present disclosure, can he viewed as a method in programming. For example, the intent of an utterance could be a Greeting (“hello there”), a RequestRepeat (“could you repeat that”) or a BuyFruit (“I want to buy an apple”). Each intent can be expressed using many different combinations of words. Utterances can also contain semantic entities, i.e., parts of the utterance that represent concepts such as city, color, time or date. Entities, as used in the present disclosure, can be viewed as parameters to the method (which method corresponds to the intent). As an example, the BuyFruit intent may have an entity Fruit that specifies the fruit to be bought.

According to an example embodiment of a method according to the present disclosure, appropriate context VA dialog will be chosen, e.g., by an application server, based on the identified relevant topic.

According to an example embodiment of a method according to the present disclosure, once the VA dialog and/or the topic component has been identified by the VA platform, intents, entities and variables will be injected into the VA memory (e.g., VA dialog) based on contextual extraction.

According to an example embodiment of a method according to the present disclosure, upon VA initiation by a user, appropriate context data are implicitly fed into the VA dialog to provide the user with the contextually correct response.

### BRIEF DESCRIPTION OF THE FIGURES

FIG. 1 illustrates a schematic process flow diagram of an example method according to the present disclosure.

FIG. 2 illustrates an overall network of hardware components according to the present disclosure.

### DETAILED DESCRIPTION

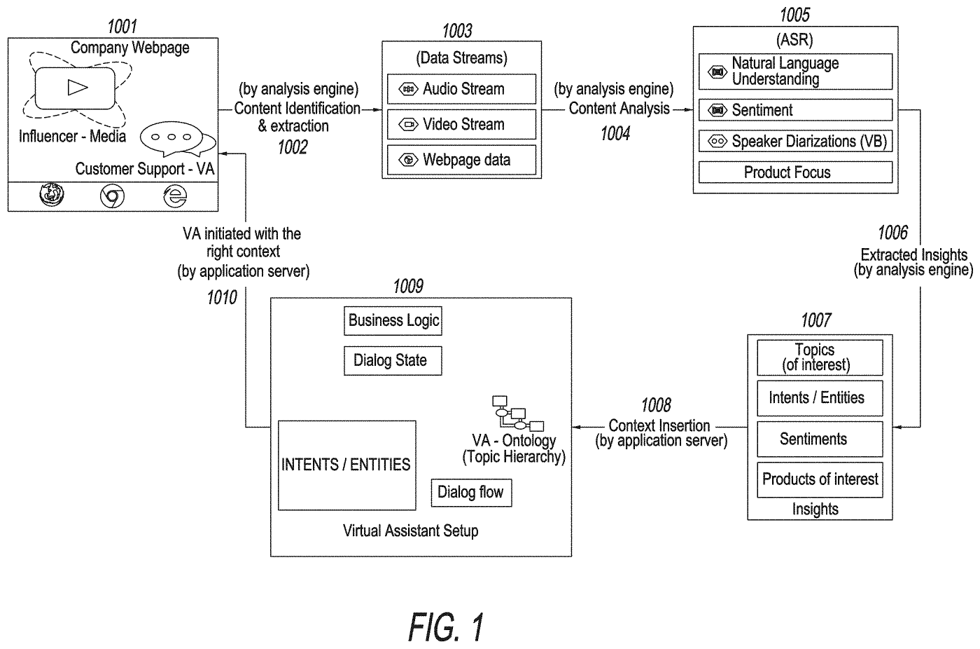

FIG. 1 illustrates a schematic process flow diagram of an example method according to the present disclosure. FIG. 1 shows a digital enterprise platform, e.g., company webpage 1001, on which customer support VA and influencer media are provided. As shown by process arrow 1002, identification and extraction of content on the webpage is performed by an analysis engine, e.g., identification and extraction of relevant widgets and objects on the webpage which carry contextual value. As shown in block 1003, examples of relevant widgets and object on the webpage include page content (webpage data) and media widgets (video stream and audio stream).

As shown by process arrow 1004 in FIG. 1, the analysis engine performs content analysis on the extracted page content and media widgets, e.g., using appropriate machine learning (ML) models. As shown in block 1005, examples of machine learning models include, e.g., Automatic Speech Recognition (ASR) (e.g., for transcribing text to speech), Natural Language Understanding (NLU) for extraction of meaning from spoken sentences, speaker diarization (the task of segmenting audio recordings by speaker labels, i.e., who speaks when), sentiment analysis on media streams (excitement, sadness, happiness, etc.), and product focus (also called web analytics, e.g., extract web page information and user interactions such as browsing history after login, mouse motion, clicks, etc.).

According to an example embodiment, an ASR platform can be implemented as a service platform powered by a speech-to-text engine that performs and converts speech into text in real time. An example embodiment of the speech-to-text engine can work with data packs in multiple languages and/or use domain language models and word sets to customize recognition for specific environments. In an example embodiment, an open source remote procedure call (RPC) software protocols provided by the ASR platform can be used to i) enable client applications to request speech recognition services in any of the programming languages supported by the RPC software, and ii) enable applications to compile word sets for use in recognition. In an example embodiment, the RPC software uses HTTP/2 for transport and protocol buffers (e.g., Protocol Buffers version 3, also known as proto3) to define the API.

According to an example embodiment, a speaker diarization platform can be implemented to include a voice verification library, which enables speaker identification (e.g., in cases when two or more speakers are conversing in the digital media), verification and audio segmentation to achieve audio diarization to obtain speech from a media influencer or a speaker of choice. In an example embodiment, the voice verification library is implemented a software library for identifying and verifying speakers in audio sources.

A. Identification: The voice verification library can be used in speaker identification, segmentation of conversation into mono audio files, language identification, gender detection, signal-to noise ratio estimation and Dual Tone Multi-frequency (DTMF) detection. Speaker identification attempts to identify a speaker by comparing audio files with database of voiceprints.

B. Verification: The voice verification library can be used for biometric security application to confirm speaker's identity, e.g., to allow access to an account or a device. Speaker verification is substantially similar to speaker identification except that speaker verification validates a person's identity claim by comparing an audio file of a specific person to a single voiceprint enrolled for that person.

In this section, speaker identification process will be discussed in detail. Speaker identification is the audio processing task in which the speaker identification engine compares voices with statistical models known as voiceprints, and returns scores for the application to accept or reject each match. Speaker identification process begins with the creation of voiceprints, and can include several additional steps outlined below:

1. Enrolling voiceprints:

a. Applications create voiceprints by collecting samples of people's voices, and training statistical models of the voices. Voiceprints contain voice biometric information for a single speaker in a compact form.

b. Multi-speaker voiceprint enrollment. Applications can perform automatic diarization and voiceprint training of speech that includes many speakers. This technique saves considerable human time (for manual diarization), but the voiceprints can have lower quality speech.

2. Speaker segmentation: Applications use speaker segmentation to detect the portions of speech related to each speaker in a multi-speaker conversation.
3. Managing voiceprints and identities: Applications use handles to write voiceprints to memory buffers or files. The application stores voiceprints, audio samples, and information about the speaker's identity (if known) in a database. Subsequently, the application retrieves voiceprints from the database and uses handles to deliver the voiceprints to the speaker identification engine for processing tasks.
4. Verifying a person's identity: To authenticate a person's identity claim, applications compare the person's voice to a previously created voiceprint for that person. If the speaker identification engine returns a high verification score, the application accepts the match.
5. Verifications do not require operator intervention: When a person claims an identity, the application compares the person's voice with an associated voiceprint loaded from a database.
6. Identification of an unknown person: To identify a voice, applications compare audio of the speaker's voice with a set of previously created voiceprints. The application can submit audio of a single person, or a conversation among multiple people (the engine can automatically segment conversations into individual speakers). If the engine returns a high identification score for one of the voiceprints, the application signals a match.
7. Gender identification can be performed to distinguish voices of females and males.
8. Language identification. To distinguish the language being spoken, Automatic language identification detects the language spoken in an audio sample as follows:

a. Applications prepare the audio (each sample must contain only one language spoken) and invokes a language-identification routine to perform the language identification task.

b. The engine analyzes the speech signal, detects the language, and assigns a. language identification score representing the similarity between the analyzed audio and the loaded language model.

c. The application interprets the score values to determine the validity of the matched language.

Continuing with FIG. 1, as shown in block 1006, insights extracted from the content analysis (as shown by 1004 and 1005) are provided by the analysis engine. The extracted insights can include, e.g., topics of interest, intents and/or entities, sentiments (e.g., of speaker), and products of interest, as shown in block 1007.

Regarding the intents and/or entities, when Natural Language Understanding (NLU) machine learning model is run on top of transcribed text from speaker audio, the NUJ extracts insights or interpretations in the form of Intents and Entities. An intent is defined as the intent of an utterance, and entities are defined as additional details and/or characteristics of that intent. For example, in the statement “I want to pay 200 dollars from my checking account,” the intent is “Pay_Bill” and. Entities can be “Dollar_Amount=200” and “From_Account=Checking”.

Information regarding products of interest can be extracted from the media. For example, in the case of an online video including discussions about a product, the name of this product will be identified by the content analysis engine and output, which in turn can be used by the dialog model of the VA.

Next, as shown by process arrow 1008, context insertion (into VA setup) is implemented, e.g., by an application server, which formats the extracted information from the analysis engine and utilizes VA application programming interfaces (APIs) to insert the appropriate context. The VA setup is illustrated in block 1009. According to an example embodiment according to the present disclosure, appropriate context VA dialog will be chosen, e.g., by the application server, based on the identified relevant topic. An example of the VA platform is Mix™ Platform from Nuance™, which is configured to identify the appropriate node in the dialog flow (shown in block 1009) based on the provided intent/entity/variable pairs. The dialog logic can be thought of as an if/else logic based on intent/entity and additional variables.

According to an example embodiment of a method according to the present disclosure, once the VA topic has been identified by the VA platform, intents and entities will be injected into the VA dialog based on the extracted context. As shown in block 1009 of FIG. 1, the dialog state is determined by: VA ontology (topic hierarchy); business logic; dialog flow; and the extracted intents and/or entities,

According to an example embodiment of a method according to the present disclosure, upon VA initiation by a user, appropriate context data are implicitly fed into the VA dialog to provide the user with the contextually correct response. For example, the application server (or middleware) can be used to host an API to fetch the contextual data. When the VA is invoked by an end-user, the VA servers and/or platform can invoke the API for checking whether contextual data exists, and if so, the contextual data will be inserted into the VA dialog. An example of VA dialog is provided below:

i. User: is this available in Montreal?
1. Explicit intent: product_availability
2. Explicit entity: location=Montreal
3. Implicit entity: product_name=xyz (based on the extracted stream)

ii. VA: XYZ is arriving to Canada beginning of September 2021.

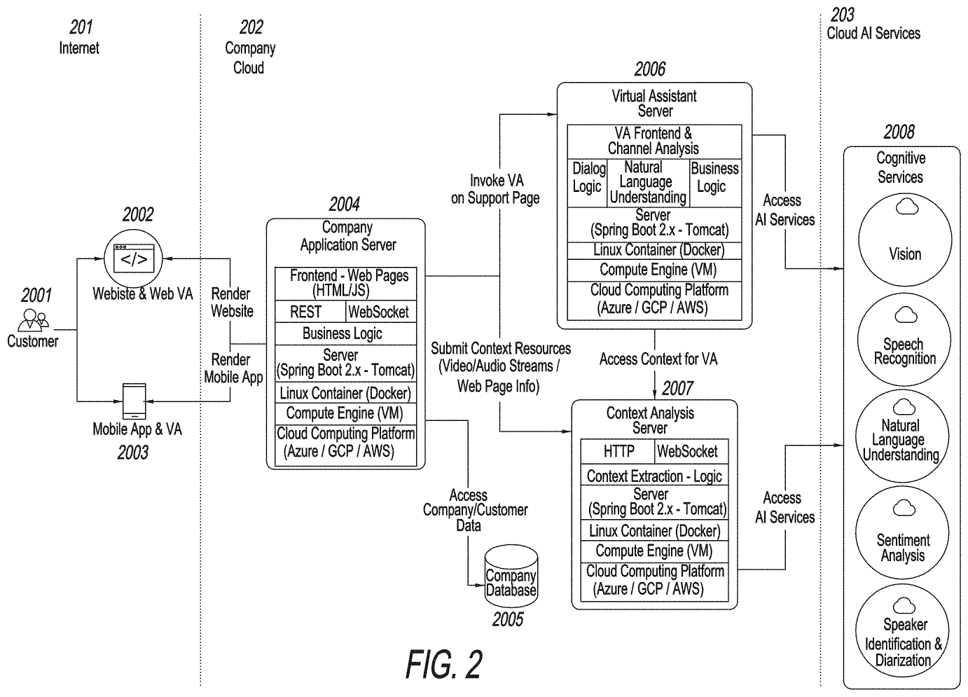

FIG. 2 illustrates an overall network of hardware components involved in implementing an example embodiment of the technique according to the present disclosure, There are three zones illustrated in FIG. 2. i.e., the Internet zone 201, company cloud sone 202, and cloud AI services zone 203. Shown in the Internet zone 201 are the customer 2001, website 2002 (which can include web VA), and mobile app 2003 (which can include VA). Shown in the company cloud zone 202 are company application server 2004, company database 2005, virtual assistant (VA) server 2006, and context analysis server 2007. Shown in the cloud AI services zone 2003 are cognitive services 2008, which includes, e.g., vision, speech recognition, natural language understanding (NLU), sentiment analysis, and speaker identification and diarization.

The company application server 2004 performs, e.g., the following functions:

1. render the website 2002 and the mobile app 2003;

2. communicate with the VA server 2006 to invoke VA on support page;

3. submit context resources (e.g., video stream, audio stream, webpage information) to the context analysis server 2007; and

4. access company and/or customer data from the company database 2005.

The company application server 2004 includes, e.g., the following components:

1. frontend, e.g., webpages defined by Hypertext Markup Language (HTML) and Java script OS);

2. Representational State Transfer (REST) application programming interface (API);

3. WebSocket;

4. business logic;

5. server core (e.g., Spring Boot™ Tomcat™);

6. Linux container (docker);

7. compute engine (virtual machine (VM)); and

8. cloud computing platform (e.g., Azure™, Google™ Cloud Platform (GCP), or Amazon™ Web Service (AWS)).

The VA server 2006 performs, e.g., the following functions:

1. communicate with the cognitive services 2008 to access component AI services; and

2. communicate with the context analysis server 2007 to access context information for the VA.

The VA server 2006 includes, e.g., the following components:

1. VA frontend and channel adapters;

2. dialog logic;

3. Natural Language Understanding (NLU);

4. business logic;

5. server core (e.g., Spring Boot™ Tomcat™);

6. Linux container (docker);

7. compute engine (virtual machine (VM)); and

8. cloud computing platform (e.g., Azure™, Google™ Cloud Platform (GCP), or Amazon™ Web Service (AWS)).

The context analysis server 2007 accesses the component artificial intelligence (AI) services of the cognitive services 2008 to perform context analysis. The context analysis server 2007 includes, e.g., the following components:

1. Hypertext Transfer Protocol (HTTP);

2. WebSocket;

3. context extraction logic;

4. server core (e.g., Spring Boot™ Tomcat™);

5. Linux container (docker);

6. compute engine (virtual machine (VM)); and

7. cloud computing platform e.g., Azure™, Google™ Cloud Platform (GCP), or Amazon™ Web Service (AWS)).

The components of the cognitive services 2008 are self-explanatory and/or have been discussed above, e.g., vision, speech recognition, natural language understanding (NUJ), sentiment analysis, and speaker identification and diarization.

As a summary, several examples of the method according to the present disclosure are provided.

A first example of the method according to the present disclosure provides a method of enabling a virtual assistant (VA) serving a user to dynamically acquire contextual information regarding digital media environment accessed by a user, comprising: extracting, by an analysis engine, the contextual information dynamically from at least one of media content accessed by the user and webpage content accessed by the user; and injecting, by the analysis engine, the extracted contextual information into a VA memory to serve the user.

A second example of the method modifying the first example of the method, the second method further comprising: analyzing, by the analysis engine, the extracted contextual information using at least one machine learning (ML) model.

In a third example of the method modifying the second example of the method, the extracted contextual information includes at least one of topics, intents, entities, sentiments, and products of interest.

In a fourth example of the method modifying the second example of the method, at least one of the intents and entities is provided by a Natural Language Understanding (NLU) machine learning model.

A fifth example of the method modifying the third example of the method, the method further comprising: selecting, by an application server, an appropriate context VA dialog based on an extracted topic.

In a sixth example of the method modifying the fifth example of the method, at least one of the intents and entities is injected into the appropriate context VA dialog by the application server.

In a seventh example of the method modifying the first example of the method, the sentiments include a sentiment of a speaker in a media stream.

In an eighth example of the method modifying the second example of the method, the at least one machine learning (ML) model includes at least one of Automatic Speech Recognition (ASR), Natural Language Understanding (NLU), speaker diarization, sentiment analysis on media streams, and web analytics for product focus.

In a ninth example of the method modifying the eighth example of the method, the speaker diarization is implemented by a speaker diarization platform including a. voice verification library to enable speaker identification.

In a tenth example of the method modifying the eighth example of the method, the ASR is implemented by an ASR platform having at least one open source remote procedure call (RPC) software protocol to enable a client application to request a speech recognition service.

A first example of a system for dynamically acquiring contextual information regarding digital media environment accessed by a user, comprising: a virtual assistant (VA) configured to serve the user; and an analysis engine configured to: i) extract the contextual information dynamically from at least one of media content accessed by the user and webpage content accessed by the user; and ii) inject the extracted contextual information into a VA memory to serve the user.

In a second example of a system modifying the first example of the system, the analysis engine is configured to analyze the extracted contextual information using at least one machine learning (ML) model.

In a third example of a system modifying the second example of the system, the extracted contextual information includes at least one of topics, intents, entities, sentiments, and products of interest.

In a fourth example of a system modifying the second example of the system, at least one of the intents and entities is provided by a Natural Language Understanding (NLU) machine learning model.

A fifth example of a system modifying the third example of the system, the system further comprising: an application server configured to select an appropriate context VA dialog based on an extracted topic.

In a sixth example of a system modifying the fifth example of the system, at least one of the intents and entities is injected into the appropriate context VA dialog by the application server.

In a seventh example of a system modifying the first example of the system, the sentiments include a sentiment of a speaker in a media stream.

In an eighth example of a system modifying the second example of the system, the at least one machine learning (ML) model includes at least one of Automatic Speech Recognition (ASR), Natural Language Understanding (NLU), speaker diarization, sentiment analysis on media streams, and web analytics for product focus.

In a ninth example of a system modifying the eighth example of the system, the speaker diarization is implemented by a speaker diarization platform including a voice verification library to enable speaker identification.

In a tenth example of a system modifying the eighth example of the system, the ASR is implemented by an ASR platform having at least one open source remote procedure call (RPC) software protocol to enable a client application to request a speech recognition service.

What is claimed is:

1. A method of enabling a virtual assistant (VA) serving a user to dynamically acquire contextual information regarding digital media environment accessed by a user, comprising:
extracting, by an analysis engine, the contextual information dynamically from at least one of media content accessed by the user and webpage content accessed by the user: and
injecting, by the analysis engine, the extracted contextual information into a VA memory to serve the user.

2. The method of claim 1, further comprising:
analyzing, by the analysis engine, the extracted contextual information using at least one machine learning (ML) model.

3. The method of claim 2, wherein the extracted contextual information includes at least one of topics, intents, entities, sentiments, and products of interest.

4. The method of claim 2, wherein at least one of the intents and entities is provided by a Natural Language Understanding (NLU) machine learning model.

5. The method of claim 3, further comprising:
selecting, by an application server, an appropriate context VA dialog based on an extracted topic.

6. The method of claim 5, wherein at least one of the intents and entities is injected into the appropriate context VA dialog by the application server.

7. The method of claim 1, wherein the sentiments include a sentiment of a speaker in a media stream.

8. The method of claim 2, wherein the at least one machine learning (ML) model includes at least one of Automatic Speech Recognition (ASR), Natural Language Understanding (NLU) speaker diarization, sentiment analysis on media streams, and web analytics for product focus.

9. The method of claim 8, wherein the speaker diarization is implemented by a speaker diarization platform including a voice verification library to enable speaker identification.

10. The method of claim 8, wherein the ASP. is implemented by an ASR platform having at least one open source remote procedure call (RPC) software protocol to enable a client application to request a speech recognition service.

11. A system for dynamically acquiring contextual information regarding digital media environment accessed by a user, comprising:
a virtual assistant (VA) configured to serve the user; and
an analysis engine configured to:
i) extract the contextual information dynamically from at least one of media content accessed by the user and webpage content accessed by the user; and
ii) inject the extracted contextual information into a VA memory to serve the user.

12. The system of claim 11, wherein the analysis engine is configured to analyze the extracted contextual information using at least one machine learning (ML) model.

13. The system of claim 12, wherein the extracted contextual information includes at least one of topics, intents, entities, sentiments, and products of interest.

14. The system of claim 12, wherein at least one of the intents and entities is provided by a Natural Language Understanding (NLU) machine learning model.

15. The system of claim 13, further comprising:
an application server configured to select an appropriate context VA dialog based on an extracted topic.

16. The system of claim 15, wherein at least one of the intents and entities is injected into the appropriate context VA dialog by the application server.

17. The system of claim 11, wherein the sentiments include a sentiment of a speaker in a media stream.

18. The system of claim 12, wherein the at least one machine learning (ML) model includes at least one of Automatic Speech Recognition (ASR), Natural Language Understanding (NLU), speaker diarization, sentiment analysis on media streams, and web analytics for product focus.

19. The system of claim 18, wherein the speaker diarization is implemented by a speaker diarization platform including a voice verification library to enable speaker identification.

20. The system of claim 18, wherein the ASR is implemented by an ASR platform having at least one open source remote procedure call (RPC) software protocol to enable a client application to request a speech recognition service.
